(19) United States
(12) Patent Application Publication
(10) Pub. No.: US 2026/0318379 A1
(43) Pub. Date: Oct. 15, 2026

(54) Adaptor for a Container Lifting Assembly of a Storage and Retrieval System

(71) Applicant: Ocado Innovation Limited, Hatfield (GB)

(72) Inventors: Sorin MIHAI, Hatfield (GB); Evgeni ZHELYAZKOV, Sofia (BG)

(21) Appl. No.: 19/463,447

(22) Filed: Jan. 29, 2026

Related U.S. Application Data
(63) Continuation of application No. PCT/EP2024/071363, filed on Jul. 26, 2024.

(30) Foreign Application Priority Data
Aug. 3, 2023 (GB) 2311925.8

(51) Int. Cl. F16D 67/00; B65G 1/04; B66C 19/00; F16D 121/18

(52) U.S. Cl. CPC F16D 67/00; B65G 1/0464; B66C 19/00; F16D 2121/18

(57) ABSTRACT

An adaptor for coupling a rotational drive mechanism to a container lifting assembly of a robotic load handling device, the container lifting assembly including a grabber device configured to engage with a storage container; a plurality of timing pulleys and; a lifting drive mechanism comprising a drive shaft coupled to the plurality of timing pulleys for raising and lowering the grabber device. The adaptor including a body comprising a first portion configured to engage with the robotic load handling device and a second portion having an opening for receiving the rotational drive mechanism; a shaft configured to releasably couple with the container lifting assembly and to releasably couple with the rotational drive mechanism such that in use, when the drive bit is coupled to the container lifting assembly, the rotational drive mechanism overrides the lifting drive mechanism of the container lifting assembly to raise and lower the grabber device.

### RELATED APPLICATIONS

This application is a continuation of International Patent Application No. PCT/EP2024/071363 entitled “An Adaptor for a Container Lifting Assembly of a Storage Retrieval System” filed 26 Jul. 2024, which claims priority to UK Patent Application No. GB2311925.8 entitled “An Adaptor for a Container Lifting Assembly of a Storage Retrieval System” filed 3 Aug. 2023; the entire contents of all of which applications are incorporated herein by reference.

### FIELD OF THE INVENTION

The present invention relates to the field of automated order fulfilment systems. In particular, the present invention relates to an adaptor for winching a grabber device of a container lifting assembly of a robotic load handling device.

### BACKGROUND

Various forms of both fully- and semi-automated order processing and fulfilment systems are known. They, and the various components they comprise, may take many forms.

Storage and retrieval systems typically comprise a three-dimensional storage grid framework structure, within which storage containers/bins are stacked on top of each other, are well known. PCT Publication No. WO2015/185628A (Ocado Innovation Ltd) and corresponding U.S. Pat. No. 10,086,999 describe a known storage and fulfilment system in which stacks of bins or containers are arranged within a grid framework structure. The bins or containers are accessed by robotic load handling devices remotely operative on tracks located on the top of the grid framework structure. A system of this type is illustrated schematically in FIGS. 1 to 3 of the accompanying drawings. For the avoidance of doubt, the term “grid framework structure” is used to mean a three-dimensional structure within which the storage containers are stored, and the terms “grid structure” and “grid” are used interchangeably to mean the two-dimensional structure in a substantially horizontal plane upon which the load handling devices operate. The above-noted U.S. Pat. No. 10,086,999 is incorporated herein by reference in its entirety.

As shown in FIGS. 1 and 2, stackable containers, known as bins or containers 10, are stacked on top of one another to form stacks 12. The terms “bin”, “container”, “storage container” and “tote” are used interchangeably in this description to refer to the same object. The stacks 12 are arranged in a grid framework structure 14 in a warehousing or manufacturing environment. The grid framework structure is made up of a plurality of storage columns or grid columns 15. Individual storage containers may be stacked in the storage columns, and their locations in the grid framework structure or “hive” may be indicated using co-ordinates in three dimensions to represent the load handling device or a container's position and a container depth, e.g., container at (X, Y, Z), depth W. Equally, locations in the grid framework structure may be indicated in two dimensions to represent the load handling device or a container's position and a container depth, e.g., container at (X, Y), depth Z. For example, Z=1 identifies the uppermost layer of the grid framework structure, i.e. the layer immediately below the rail system, Z=2 is the second layer below the rail system and so on to the lowermost, bottom layer of the grid framework structure. The height of the grid framework structure various from as high as 21 storage containers high to one storage container high. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application.

The three-dimensional grid framework structure 14 comprises a plurality of upright members or vertical members or upright columns 16 that support horizontal grid members 18, 20. A first set of parallel horizontal grid members 18 is arranged perpendicularly to a second set of parallel horizontal grid members 20 to form a grid structure lying in a horizontal plane and supported by the upright members 16. The vertical and horizontal members 16, 18, 20 are typically manufactured from metal and typically welded or bolted together or a combination of both. The bins 10 are stacked between the vertical members 16 of the grid framework structure 14, so that the grid framework structure 14 guards against horizontal movement of the stacks 12 of bins 10, and guides vertical movement of the bins 10.

The top level of the grid framework structure 14 comprise a track system comprising a plurality of rails or tracks 22 arranged in a grid pattern across the top of the stacks 12. Referring additionally to FIG. 3, the rails 22 support a plurality of load handling devices 30. A first set 22a of parallel rails or tracks 22 guide movement of the robotic load handling devices 30 in a first direction (for example, an X-direction) across the top of the grid framework structure 14, and a second set 22b of parallel rails or tracks 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

As an alternative to the grid framework structure 14 supporting the 2D grid directly on a plurality of upright columns 16 as described with reference to FIG. 1, in other examples the grid framework structure supports the 2D grid on top of a plurality of prefabricated modular panels arranged in a three dimensional grid pattern, the detail of which is described briefly below and fully in the PCT application, WO2022034195A1 (Ocado Innovation Ltd) and corresponding US Patent Application Publication No. US20250066120, the entire content of which is incorporated herein by reference. Each of the grid cells of the supporting framework structure is sized to support two or more grid cells of the 2D grid upon which the load handling devices operate. The grid framework structure is formed from fewer structural components yet still maintains the same structural integrity as the typical “stick-built” grid framework structure 14 described above, and is much faster and cheaper to build.

Like the grid framework structure described above with reference to FIG. 1, the prefabricated modular panels of the grid framework structure comprise upright columns or vertical members 16. For example, a sub-group of the upright columns can be braced by one or more bracing members to form prefabricated panels or frames. For the purpose of the present invention, the plurality of upright columns 16 can also include the upright columns 16 of the prefabricated panels. The grid framework structure can comprise any appropriate supporting framework structure to support the grid structure, including upright columns 16 directly supporting the grid, and/or prefabricated panels and/or frames incorporating upright columns 16.

A known load handling device 30 shown in FIGS. 4 and 5 comprising a vehicle body 32 is described in PCT Patent Publication No. WO2015/019055 (Ocado Innovation Ltd), and its corresponding U.S. Pat. No. 10,000,337, the entire content of which is incorporated herein by reference, where each load handling device 30 only covers one grid space of the grid framework structure 14. Here, the load handling device 30 comprises a wheel assembly comprising a first set of wheels 34 consisting a pair of wheels on the front of the vehicle body 32 and a pair of wheels 34 on the back of the vehicle 32 for engaging with the first set of rails or tracks to guide movement of the device in a first direction and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction.

The load handling device 30 is equipped with a lifting device (container lifting mechanism or container lifting assembly) or crane mechanism to lift a storage container from above. The crane mechanism comprises a winch, a tether or cable 38 wound on a spool or reel (not shown) and a grabber device 39. An example of a crane mechanism for lifting and lowering grabber device is described in PCT Patent Publication No. WO2021148657 (Ocado Innovation Limited) and corresponding US Patent Publication No. US2023116001, the entire content of which is incorporated herein by reference. The lifting device or crane mechanism comprise a set of lifting tethers 38 extending in a vertical direction and connected nearby or at the four corners of a lifting frame 39, otherwise known as a grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2. The grabber device comprises a plurality of grippers that are configured to grip a storage container when actuated by an actuator.

The wheels 34, 36 are arranged around the periphery of a cavity or recess, known as a container-receiving recess or container receiving space 40, in the lower part of the load handling device. The recess is sized to accommodate the container 10 when it is lifted by the crane mechanism, as shown in FIG. 5, views (a) and (b). When in the recess, the container is lifted clear of the rails beneath, so that the vehicle or load handling device can move laterally to a different location. On reaching the target location, for example another stack, an access point in the storage system or a conveyor belt, the bin or container can be lowered from the container receiving portion and released from the grabber device.

The container receiving space 40 may comprise a cavity or recess arranged within the vehicle body, e.g. as described in the above-noted WO2015/019055 (Ocado Innovation Limited). Alternatively, the vehicle body of the load handling device may comprise a cantilever as taught in WO2019/238702 (Autostore Technology AS) in which case the container receiving space is located below a cantilever of the load handing device. In this case, the grabber device is hoisted by a cantilever such that the grabber device is able to engage and lift a container from a stack into a container receiving space below the cantilever.

Upon receipt of a customer order, a load handling device operative to move on the tracks is instructed to pick up a storage container containing the item of the order from a stack in the grid framework structure and transport the storage bin to a pick station whereupon the item can be retrieved from the storage bin.

It is highly preferably that during a picking operation the grabber device remains horizontal at all times, particularly when engaging with a storage container, otherwise there is the potential risk that at least one of the lifting tethers holding the grabber device may tear if subjected to unbalanced and high loads. To possess the necessary physical properties (Young's Modulus) to bear the load of the storage container, which can be as heavy as 35 kg (77 lbs), the lifting tethers are generally in the form of a tape or band, usually made of metal (commonly a steel alloy). In this description, the terms “tethers” and “tapes” and “bands” are used interchangeably, though it will be understood that the tethers are not limited to tapes or bands, and can take any appropriate form.

To ensure that the grabber device remains horizontal, is it is important that the length of all of the tapes is kept the same at all times during operation of the grabber device. To ensure that the length of all of the tethers anchored to the grabber device are the equal such that the grabber device is kept horizontal during operation, the length of each of the tapes is preferably adjusted both initially, as well as at various service intervals since they tend to elongate or stretch over time which can be attributed to numerous factors such as environmental, motor wear, stretching of the tape and so on. In an extreme case where the length of any one of the tapes is not equal, the container gripping assembly may fail to engage with the container either because its descent falls too short or overshoots the container. Traditionally, the tapes are connected and spooled onto separate reels arranged within an upper level of the housing or body of the load handling device. The travel length of a lifting band per rotation of the spool onto which the lifting band is reeled is dependent on the number of layers of the lifting band wound onto the spool.

To adjust a tape and to remove any slack in the reel, the corresponding spool or reel may be disconnected from a rotational shaft and the tape adjusted by free rotation of the reel or spool relative the rotational shaft. The reel or spool is subsequently mounted to the rotational shaft when the band has the desired length. A variant to this method is to provide adjustable lifting band connectors fixed to the container gripping assembly as taught in WO 2019/206438 (Autostore Technology) and corresponding U.S. Pat. No. 11,434,075, the entire content of which is incorporated herein by reference. Each adjustable lifting connector comprises a bracket and a band connector hub. The bracket is connected to the container gripping assembly, and the band connector hub is connected to the bracket and one of the lifting bands, such that movement of the band connector hub relative to the bracket will adjust the vertical distance between a respective corner section of the container gripping assembly and the lifting band drive assembly.

The use of lifting tapes to suspend the container gripping assembly from the spools provides the advantage that the length of the tape extending between the container gripping assembly and the spools can be precisely controlled. This is because the lifting tape has a predetermined uniform thickness such that the number of turns of the tape as it is wound around the spool can be easily calculated. The tape is generally relatively thin (usually about 0.1 to 0.3 mm thickness) to enable multiple overlaps of the tape to be wound on a spool. This greatly increases the length of tape that can be spooled or drawn out from the spool, and thereby allows the container gripping assembly suspended from the lifting tape to reach storage containers stored at greater depths within the storage system, which can be as high as 21 storage containers.

However, the problem with the use of tape to suspend the container gripping assembly from the spool is that the tape is susceptible to being damaged. This is particularly exacerbated where the thickness of the tape is relatively thin to enable multiple overlaps of the lifting tape to be wound on the spool. Any kinking of lifting tapes affects the length of an individual tape, and thus the separation between the spool and the container gripping assembly. Kinking is a permanent crease or bend or twist that has developed in the tape and is particularly pronounced in examples where the lifting tape is composed of metal. As a result, a portion of the length of the tape is taken up by the kink. Since the container gripping assembly is suspended by more than one lifting tape, any variation in length in any one of the tapes due to kinking affects the orientation of the container gripping assembly relative to a horizontal plane, and thereby potentially affects its ability to engage with a storage container below.

Any unevenness of the grabber device may inevitably result in the grabber device becoming jammed in a storage column as it is being hoisted towards the load handling device operative on the track system. For example, the lifting frame of the grabber device may be caught up against one or more of the vertical upright members or vertical members. This may result in the load handling device being prevented from moving on the grid framework structure as its grabber device is still anchored to the grid framework structure. In a worst-case scenario, one or more of the lifting tethers may have to be cut in order to free up the load handling device on the grid framework structure so that the load handling device can be rescued and transported to a service station for maintenance. The cutting of one or more tapes to free up the load handling device from its grabber device is not only limited to the grabber device becoming jammed in a storage column but can result from other deficiencies in the normal operation of the container lifting assembly. Malfunctions in the operation of the container lifting assembly can include malfunctions in the operation of one or more of the lifting motors used to winch the grabber device, insufficient charge in the on-board power source to operate the lifting motors, etc. The cutting of one or more tapes in order to free up the load handling device on the grid framework structure would remove the ability of the load handing device to retrieve storage containers from a stack of storage containers, which in turn would make the load handling device inoperable on the grid framework structure.

In all cases, the load handling device would have to be freed from its grabber device in order for the load handling device to be rescued by a service vehicle operable on the grid framework structure and taken to a service station for maintenance. Example of service vehicles operable on the grid framework structure include the service vehicles taught in WO 2015/140216 (Ocado Innovation Ltd) and its corresponding U.S. Pat. No. 10,836,577, WO2019233749 (Autostore Technology AS) and its related U.S. Pat. No. 12,145,012, WO2020151866 (Autostore Technology AS) and its corresponding U.S. Pat. No. 12,214,960, and a manual service vehicle as taught in WO2022175561 (Ocado Innovation Ltd) and its corresponding U.S. Pat. No. 12,478,810; all of which patent application publications and patents are incorporated herein by reference in their respective entireties.

A device is thus required that would enable the grabber device to be freed from the load handling device without the need to cut one or more of the lifting tethers.

### SUMMARY OF THE DISCLOSURE

The present invention has mitigated the above problem by providing an adaptor or device for attaching a rotational drive mechanism for overriding the lifting drive mechanism of the container lifting assembly to raise the grabber device above the tracks of the grid framework structure, as illustrated herein with reference to certain examples and embodiments. Use of such adaptors can remove the need to cut one or more of the lifting tethers (or similar structures) of the container lifting assembly to free up the robotic load handling device on the tracks. More specifically, examples and embodiments in accordance with the present disclosure can provide an adaptor for coupling a rotational drive mechanism to a container lifting assembly of a robotic load handling device, the container lifting assembly comprising (i) a grabber device configured to engage with a storage container; (ii) a plurality of timing pulleys; and (iii) a lifting drive mechanism comprising a drive shaft coupled to the plurality of timing pulleys for raising and lowering the grabber device, the adaptor comprising:
(a) a body comprising a first portion configured to engage with the robotic load handling device and a second portion having an opening for receiving the rotational drive mechanism,
(b) a shaft having a first end extending through the body to define a drive bit, the drive bit being configured to releasably couple with the container lifting assembly and a second end configured to releasably couple with the rotational drive mechanism such that, in use, when the drive bit is coupled to the container lifting assembly, the rotational drive mechanism overrides the lifting drive mechanism of the container lifting assembly to raise the grabber device in a first rotational direction of the rotational drive mechanism and lower the grabber device in a second rotational direction of the rotational drive mechanism; and
(c) a releasable brake mechanism coupled to the shaft and configured to brake rotation of the shaft in the second rotational direction.

Optionally, the rotational drive mechanism can comprise a handheld drill or other handheld rotational drive mechanism. Optionally, the second end of the shaft is coupled to the rotational drive mechanism such that the shaft and the rotational drive mechanism is formed as a single body. The rotational drive mechanism functions as a secondary drive mechanism that is configured to override the lifting drive mechanism of the container lifting assembly to raise the grabber device above the tracks so as to enable the robotic load handling device to be recovered. As a result, adaptors according to the present invention (present disclosure) can enable an operator to walk out on the track system, e.g. with the assistance of a restraint system as taught in the above-noted International Patent Application Publication WO2022175561 (Ocado Innovation Ltd), to a malfunctioned robotic load handling device and manually winch the grabber device into the container receiving space. In order to releasably couple the adaptor to the container lifting assembly, the adaptor comprises a shaft having a first end that is configured to releasably couple with the container lifting assembly, more specifically to at least one of the plurality of timing pulleys of the container lifting assembly, and a second end configured to releasably couple with the rotational drive mechanism to drive rotation of the shaft.

Considering that the grid framework structure can be as high as 21 storage containers high, where each storage container has a height of 36 cm, the potential energy of the grabber device when the grabber device is above the tracks can be relatively high. This is particularly the case when a storage container weighing up to 35 kg is attached to the grabber device. For safety reasons, the brake mechanism prevents the shaft from freely rotating in the second rotational direction when the grabber device is winched above the tracks, should the rotational drive mechanism be removed from the shaft or be stopped. To prevent the lifting tethers from unwinding on their respective spools once the grabber device has been winched above the tracks, resulting in the grabber device falling down a storage column, the releasable brake mechanism is configured to brake rotation of the at least one of the plurality of timing pulleys in the second rotational direction.

The second rotational direction can be in a clockwise direction or an anti-clockwise direction depending on the orientation of the spools carrying the lifting tethers on their respective lifting shafts. The rotational direction of the rotational drive mechanism to raise and lower the grabber device can be the same as rotational direction of the lifting drive mechanism, in which case, the lifting drive mechanism raises in the grabber device in the first rotational direction and lowers the grabber device in the second rotational direction. Actuation of the releasable brake mechanism to brake rotation of the spools also removes the load being applied to the rotational drive mechanism to keep the grabber device in the raised position. To brake rotation of the grabber device, particularly when the grabber device is in the raised position, optionally, the releasable brake mechanism is coupled to the shaft such that when the releasable brake mechanism is applied the shaft is prevented from rotating in the second rotational direction. This could be directly coupled to the shaft. For example, the body can comprise the releasable brake mechanism that is directly coupled to the shaft and is configured to brake rotation of the shaft. Alternatively, or additionally, the releasable brake mechanism can be indirectly coupled to the shaft via the rotational drive mechanism. For example, the releasable brake mechanism can be incorporated into the rotational drive mechanism. Most handheld drills comprise a built-in locking mechanism that prevents rotation of the handheld drill in the opposite direction to the driving direction.

In addition to winching the grabber device above the tracks, the rotational drive mechanism can also be used to free up a grabber device caught up in a storage column. For example, the releasable one-way brake mechanism can be configured to apply a tension to the lifting tethers to free up a grabber device caught up against one or more vertical uprights of the grid framework structure. Agitation of the grabber device can be achieved by lifting and lowering the grabber device to cause the grabber device to loosen from its storage column.

Optionally, the releasable brake mechanism is a releasable one-way brake mechanism comprising: (i) a ratchet wheel comprising a plurality of teeth radially extending therefrom; and (ii) a pawl moveable between a ratchet engaged position, in which the pawl is engaged with at least one of the plurality of teeth to brake rotation of the ratchet wheel in the second rotational direction, and a ratchet released position to permit rotation of the ratchet wheel.

The ratchet wheel is, optionally, coupled to the shaft in the sense that rotation of the shaft drives rotation of the shaft, i.e. mounted to the shaft. Optionally, the adaptor further comprises a locking lever coupled to the pawl to move the pawl between the ratchet engaged position and the ratchet released position. When in the ratchet engaged position, the shaft is prevented from rotating. Optionally, the pawl is biased in the ratchet engaged position.

As an added safety measure, the shaft is coupled to the releasable brake mechanism via a one-way clutch or sprag clutch for transferring rotation of the shaft to the brake mechanism in the first rotational direction but prevent the shaft from rotating the brake mechanism in the second rotational direction. The one-way clutch or sprag clutch can be arranged on the shaft such that the clutch slips when rotating the shaft in the second rotational direction but engages to transmit a rotational torque to the brake mechanism when rotating in the opposite, first rotational direction.

To safely remove the rotational drive mechanism from the adaptor when the grabber device has been winched above the tracks, e.g. in the container receiving space of the robotic load handling device, the adaptor further comprises a removable locking member for engaging with the at least one of the plurality of timing pulleys. Optionally, the locking member can be at least one locking pin that is inserted into at least one of the plurality of timing pulleys, thereby preventing the at least one of the plurality of timing pulleys from rotating; more specifically, into an opening in the at least one of the plurality of timing pulleys from rotating. Optionally, the at least one locking pin comprises a first locking pin and a second locking pin, each of the first and second locking pins being insertable into respective first and second openings of the at least one of the plurality of timing pulleys. The second locking pin provides some redundancy to the locking of the at least one of the plurality of timing pulleys should the first locking pin is prevented from being inserted in its respective first opening. Optionally, the second opening is larger than the first opening. In the event the first pin is prevented from being inserted into the first opening due to misalignment with the at least one of the plurality of timing pulleys, the larger second opening allows the second locking pin to be inserted into its respective second opening.

Preferably, the adaptor comprises a body, the body comprising a first portion configured to engage or interface with the robotic load handling device and a second portion having an opening for receiving the rotational drive mechanism, the first end of the shaft extending through the first portion of the body to define a key or drive bit for coupling with the at least one of the plurality of timing pulleys such that rotation of the shaft rotates the key or drive bit relative to the body when the body is engaged with the load handling device. Optionally, the body of the adaptor comprises one or more engagement features configured to engage with the load handling device such that any reaction forces when the rotational drive mechanism rotates is transmitted through the robotic load handling device. Without this engagement feature, torque from the rotational drive mechanism is transmitted to an operator's hand. For example, where the rotational drive mechanism is a handheld drill, the torque lifting a fully loaded storage container can apply undue stress on the operator's hand. Having a body that engages with the robotic load handling device transmits this torque to the load handling device such that the rotational drive mechanism drives the shaft relative to the body.

Examples and embodiments of the present invention can/do provide a robotic load handling device for lifting and moving one or more containers stackable in a storage and retrieval system, the storage and retrieval system comprising a grid structure comprising a plurality of grid members arranged in a grid pattern for guiding the movement of the load handling device on the grid structure, the load handling device comprising:
(a) a container lifting assembly comprising: (i) a grabber device configured to releasably grip a storage container; (ii) a plurality of spools, each spool of the plurality of spools carrying a lifting tether having a first end anchored to the grabber device and a second end anchored to the spool; (iii) a lifting drive mechanism; and (iv) a plurality of timing pulleys to transfer rotation of the lifting drive mechanism to the plurality of spools to raise and lower the grabber device;
(b) a wheel assembly comprising a first set of wheels for engaging with a first set of grid members to guide movement of the load handling device in a first direction and a second set of wheels for engaging with a second set of grid members to guide the movement of the load handling device in a second direction, wherein the second direction is transverse to the first direction; and
(c) a wheel positioning mechanism configured for selectively lowering or raising the first set of wheels or the second set of wheels into engagement or disengagement with the first set of grid members or the second set of grid members;
wherein at least one of the plurality of timing pulleys of the container lifting assembly is configured to interface with an adaptor according to the present invention.

Optionally, the at least one of the plurality of pulleys comprises a drive pulley. In order for the adaptor to engage with the drive pulley, optionally, the drive pulley comprises a connector for coupling with the first end of the shaft. The feature “timing pulley” and “pulley” are used interchangeably in the patent specification to refer to the same feature.

Optionally, the plurality of spools comprises a first set of spools and a second set of spools, the first set of spools being mounted on a first lifting shaft and the second set of spools being mounted on a second lifting shaft, the first lifting shaft being connected to the drive pulley and the second lifting shaft being connected to the first lifting shaft such that rotation of the drive pulley by the drive mechanism drives rotation of the first and second sets of spools.

Optionally, the plurality of timing pulleys comprises a first timing pulley and a second timing pulley, the first timing pulley being mounted on the first lifting shaft and the second timing pulley being mounted on the second lifting shaft, the first lifting shaft being connected to the drive pulley via the first timing pulley and the second lifting shaft being connected to the first lifting shaft via the second timing pulley.

The present invention is not limited to the noted adaptors, e.g., comprising the braking mechanism to brake rotation of the at least one of the plurality of pulleys and the braking of the at least one of the plurality of pulleys can be provided by the rotational drive mechanism or the lifting drive mechanism of the container lifting assembly. A further aspect of the present invention provides a kit of parts, e.g., comprising:
(A) an adaptor for coupling a rotational drive mechanism to a container lifting assembly of a robotic load handling device, the adaptor comprising an adaptor according to the present invention;
(B) a rotational drive mechanism releasably coupled to the second end of the shaft.

In another aspect of the present invention, the rotational drive mechanism can be coupled to the second end of the shaft. For example, the shaft and the rotational drive mechanism can be formed as a single, integral unit rather than separate units. Some commercially available handheld drills comprise a brake mechanism. Where the rotational drive mechanism is coupled to the second end of the shaft, the brake mechanism of the rotational drive mechanism can optionally brake rotation of the at least one of the pulleys of the container lifting assembly.

In yet a further aspect of the present invention, the lifting drive mechanism of the container lifting assembly can comprise a brake mechanism comprising an actuator for releasing the brake mechanism removing the need to have a separate brake mechanism.

To make of use of the one-way brake mechanism in the container lifting drive assembly, the present invention provides an adaptor for coupling to a container lifting assembly of a robotic load handling device, the container lifting assembly comprising (i) a grabber device configured to engage with a storage container; (ii) a lifting drive mechanism comprising a drive shaft coupled to a plurality of timing pulleys for raising and lowering the grabber device; (iii) a brake mechanism configured to prevent rotation of the drive mechanism; and (iv) an actuator to release the brake mechanism, the adaptor comprising:
(a) an electrical circuit comprising a power source and electrical contacts for supplying power to actuate release of the brake mechanism and permit rotation of the motor drive shaft;
(b) a shaft having a first end configured to releasably couple with the container lifting assembly and a second end configured to releasably couple with a rotational drive mechanism such that, in use, when the electrical actuator is actuated, rotation of the shaft in a first rotational direction raises the grabber device.

Typically, the lifting drive mechanism of the container lifting assembly comprises a brake or clutch mechanism that is actuated internally by a controller whenever the robotic load handling device is instructed to winch the grabber device. Actuation of the brake or clutch mechanism involves supplying electrical power to an actuator to release the brake or clutch mechanism. Instead of having a separate braking mechanism, the adaptor can optionally make use of the brake or clutch of the lifting drive mechanism. Preferably, the adaptor can comprise a power source and electrical contacts for supplying power to actuate the brake mechanism of the lifting drive mechanism. The brake mechanism can be actuated again to re-engage the brake mechanism once the grabber device has been raised above the tracks. For safety reasons, the default position would be that the brake mechanism is fully engaged until actuated to release the brake mechanism.

Examples and embodiments of the present invention can further provide a method of raising a grabber device of a container lifting assembly of a robotic load handling device, the container lifting assembly comprising (i) a plurality of timing pulleys; (iii) a lifting drive mechanism comprising a drive shaft coupled to the plurality of timing pulleys for raising and lowering the grabber device, the robotic load handling device being operable on a grid framework structure comprising a plurality of tracks arranged in a grid pattern for guiding the movement of the load handling device on the grid structure, the method comprising the steps of:
(i) offering up an adaptor according to the present invention to the load handling device such that the first end of the shaft engages with the container lifting mechanism; (ii) coupling a rotational drive mechanism to the second end of the shaft; (iii) driving rotation of the shaft by the rotational drive mechanism around the first rotational direction to raise the grabber device; and (iv) applying a brake to prevent rotation of the shaft in the second rotational direction once the grabber device is in a raised position.

The raised position is a position above the original position of the grabber device. This could be a position within the load handling device or a position below the load handling device. Once within the load handling device, the brake mechanism is applied to prevent the grabber device from lowering into the storage column. In some circumstances, the adaptor according to the present invention coupled to the rotational drive mechanism can be used to dislodge the grabber device within a storage column. This may involve raising and lowering the grabber device until it is free to move vertically along the storage column. Each time the grabber device is raised and/or lowered, the brake mechanism is applied.

### BRIEF DESCRIPTION OF THE DRAWINGS

Further features and aspects of the present invention will be apparent from the following detailed description of illustrative embodiments made with reference to the drawings, in which:

FIG. 1 is a schematic diagram of a grid framework structure according to a known system;

FIG. 2 is a schematic diagram of a top-down view showing a stack of bins arranged within the grid framework structure of FIG. 1;

FIG. 3 is a schematic diagram of a system of a known load handling device operating on the grid framework structure;

FIG. 4 is a schematic perspective view of the load handling device showing the lifting device gripping a container from above;

FIG. 5 includes views (a) and (b), which are schematic perspective cut away views of the load handling device of FIG. 4, with view (a) showing the container receiving space of the load handling device and view (b) showing a container accommodated within the container receiving space of the load handling device;

FIG. 6 is a schematic drawing showing the grabber device known in the art seated on the rim of the storage container;

FIG. 7 includes views (a) and (b), which are perspective views, witch view (a) showing an adaptor for connecting a rotational drive mechanism to the container lifting assembly being offered up to the container lifting assembly, and view (b) the rotational drive mechanism being coupled to the container lifting assembly via the adaptor;

FIG. 8 is a perspective side view of the adaptor for connecting a rotational drive mechanism to the container lifting assembly according to an example of the present invention;

FIG. 9 is a perspective rear side view of the adaptor shown in FIG. 8 showing the opening in the body of the adaptor for receiving the rotational drive mechanism;

FIG. 10 includes views (a) and (b), which are different perspective views of the releasable one-way brake mechanism of the adaptor according to an example of the present invention;

FIG. 11 is a perspective view of the adaptor according to the present invention being offered up to drive pulley of the container lifting assembly of the robotic load handling device;

FIG. 12 is a cross-sectional view of the adaptor coupled to the drive pulley of the container lifting assembly;

FIG. 13 is a cross-sectional view of the drive pulley of the container lifting assembly comprising a connector for coupling with the adaptor;

FIG. 14 is a perspective view of a separate engagement pin inserted into the drive pulley to prevent rotation of the lifting spools carrying the lifting tethers;

FIG. 15 is a perspective view of the engagement pin used to stop rotation of the drive pulley; and

FIG. 16 is a perspective cross-sectional view of the adaptor coupled to the drive pulley of the container lifting assembly.

### DETAILED DESCRIPTION

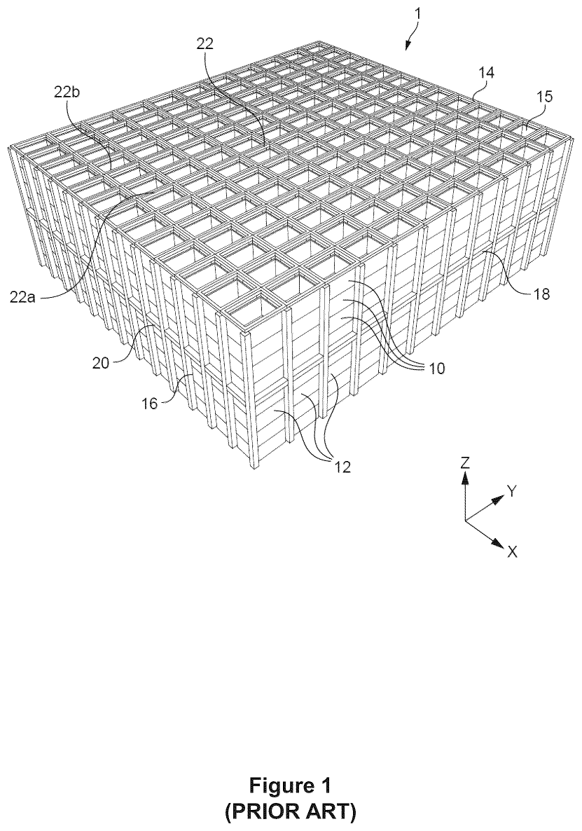

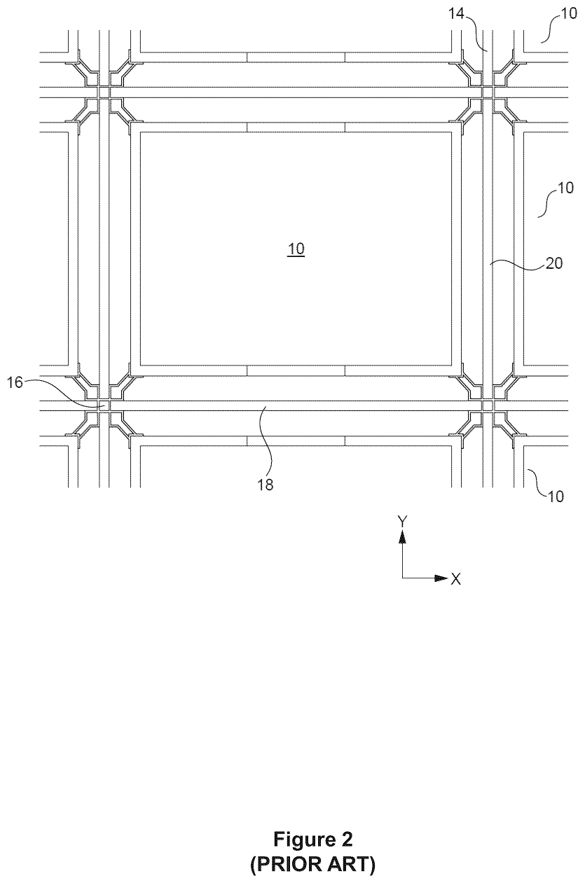

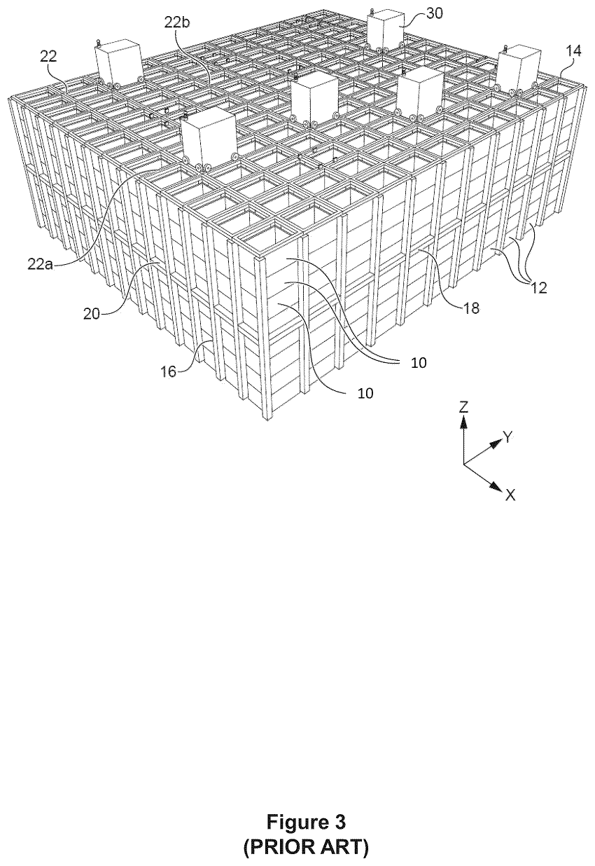

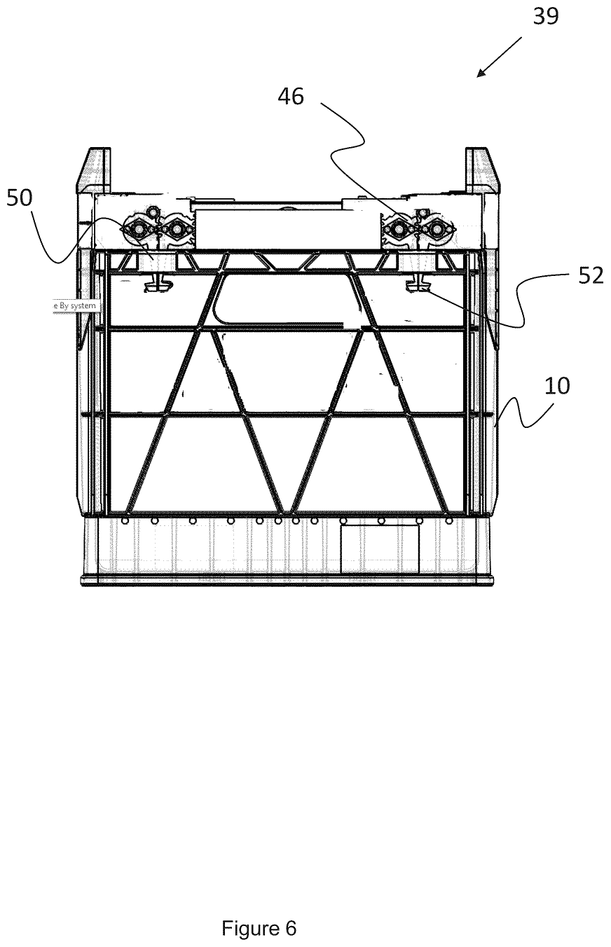

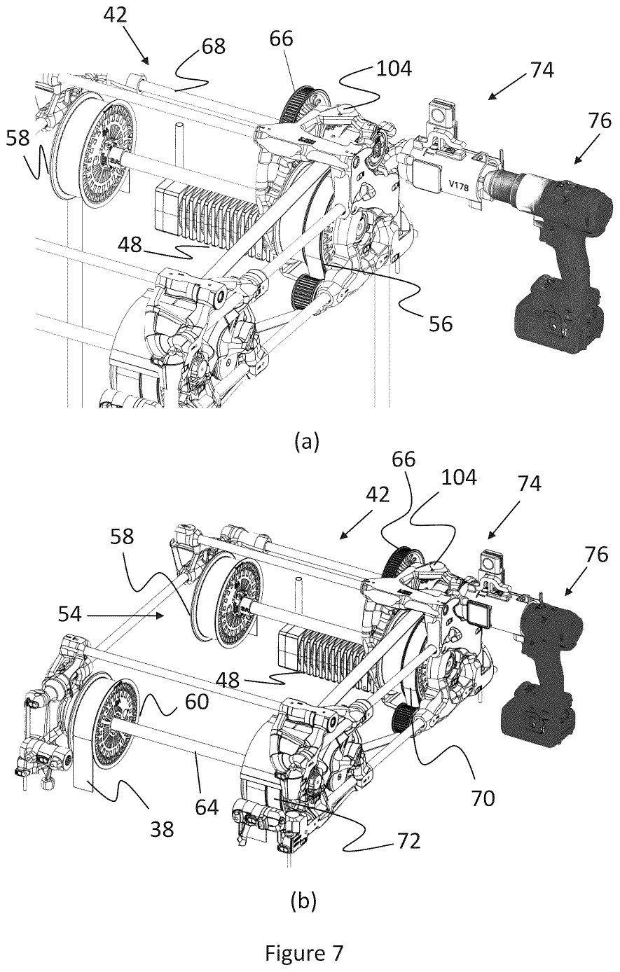

It is against the known features of the storage and retrieval system such as the grid framework structure and the load handling device described above with reference to FIGS. 1 to 5, that the present invention has been devised. As discussed in the introductory section of the patent specification, a robotic load handling device operable on the grid framework structure comprises a container lifting assembly 42 configured to raise and lower storage containers in storage in the grid framework structure—see FIG. 7, views (a) and (b). The container lifting assembly comprises a grabber device 39 comprising a lifting frame 44 supporting a plurality of gripper elements 46 that are configured to engage with features of the storage containers and a lifting drive mechanism 48 for raising and lowering the grabber device 39 up and down a storage column of the grid framework structure (see FIG. 6). Four lifting tethers 38 are connected at their lower ends to the grabber device 38. The tethers 38 may be wound up or down to raise or lower the grabber device 39, as required. The lifting tethers 38 may be in the form of cables, ropes, tapes, or any other form of tether with the necessary physical properties to lift the storage containers. For example, the storage containers may be provided with one or more apertures 50 in their upper sides with which the gripper elements 46 can engage. Alternatively or additionally, the gripper elements may be configured to hook under the rims or lips of the storage containers, and/or to clamp or grasp the storage containers. In the example shown in FIG. 6, each of the gripper elements 46 comprises a pair of wings that are collapsible to be receivable in corresponding holes 50 in the rim of the storage container and an open enlarged configuration having a size greater than the holes 50 in the rim of the storage container in at least one dimension so as to lock onto the storage container. The wings are driven into the open configuration by a drive gear. More specifically, the head of at least one of the wings comprises a plurality of teeth that mesh with the drive gear such that when the gripper elements 46 are actuated, rotation of the drive gear causes the pair of wings to rotate from a collapsed configuration to an open enlarged configuration.

When in the collapsed or closed configuration, the gripper elements 46 are sized to be receivable in corresponding holes 50 in the rim of the storage container as shown in FIG. 6. The foot of each of the pair of wings comprises a stop 52, e.g. a boss, such that when received in a corresponding holes 50 in the rim of the storage container, the stop 52 engages with an underside of the rim when in an enlarged open configuration to lock onto the storage container when the grabber device 39 is winched upwards towards the container-receiving portion of the robotic load handling device.

The raising and lowering of the grabber device may comprise a plurality of spools 54, each spool of the plurality of spools 54 carrying the lifting tether having a first end anchored to the grabber device and a second end anchored to the spool. In the particular embodiment of the present invention shown in FIG. 7, the plurality of spools 54 are driven by a lifting drive mechanism 48 via a plurality of timing pulleys and timing belts to raise and lower the grabber device. In the particular embodiment of the present invention, the lifting drive mechanism comprises a single motor 48. However, the present invention is not limited to the plurality of spools 54 being driven by a single motor and the plurality of spools can be driven by one or more motors or other means may be provided to effect or control the winding up or down of the grabber device.

In the particular example of the present invention shown in FIG. 7, the plurality of spools comprises a first set of spools 58 and a second set of spools 60. The first set of spools 58 are mounted to a first lifting shaft 62 such that the first lifting shaft is common to the first set of spools 58. The first lifting shaft 62 is rotated by being connected to the single motor 48 via at least one of the plurality of timing pulleys 66, and timing belts (not shown). The second set of spools 60 are driven by the single motor by being connected to the first lifting shaft 62 by the one or more of the plurality of timing pulleys 56 and timing belts. The second set of spools 60 is shown in FIG. 7 mounted to a second lifting shaft 64 such that the second lifting shaft 64 is common to the second set of spools 60. The plurality of timing pulleys may comprise a drive pulley 66 and first set and second set of timing pulleys 70, 72. In the particular example shown in FIG. 7, views (a) and (b), each of the first and second sets of pulleys 70, 72 comprises a single pulley. The drive pulley 66 is shown in FIG. 7 mounted to a separate shaft 68 to the first and second lifting shafts 62, 64. For the purpose of definition of the present invention, the shaft to which the drive pulley is mounted is termed a drive shaft or a lifting drive shaft. The drive pulley 66 is connected to the single motor 48 by a drive belt (not shown).

The first set of timing pulleys 70 are mounted on the first lifting shaft 62 common to the first set of spools 58 such that rotation of the first lifting shaft 62 by the single motor 48 by connection to the drive pulley 66 via a drive belt and/or drive gears drives the first set of spools 58. For the purpose of the present invention, the term “drive” is construed to mean driving in the sense of rotation. The second set of timing pulleys 72 are mounted on the second lifting shaft 64 common to the second set of spools 60. The first set of timing pulleys 70 is connected to the second set of timing pulleys 72 via one or more of the plurality of timing belts (not shown) such that rotation of the first lifting shaft 62 by the single motor 48 by connection to the drive pulley 66 drives the second set of spools 60. The present invention is not limited to the drive pulley 66 being mounted to a shaft separate to the first and second lifting shafts 62, 64. The drive pulley 66 can, optionally, be mounted to one of the first and second lifting shafts 62, 64 such that rotation of the drive pulley 66 drives rotation of the first and second lifting shafts, and thus, the first and second sets of spools 58, 60 mounted on their respective lifting shafts.

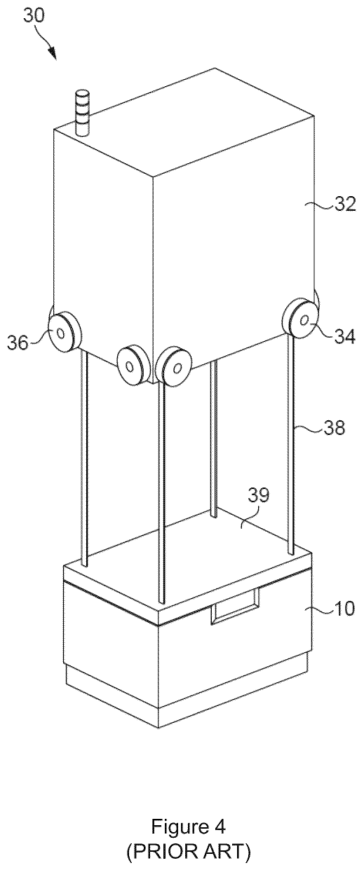

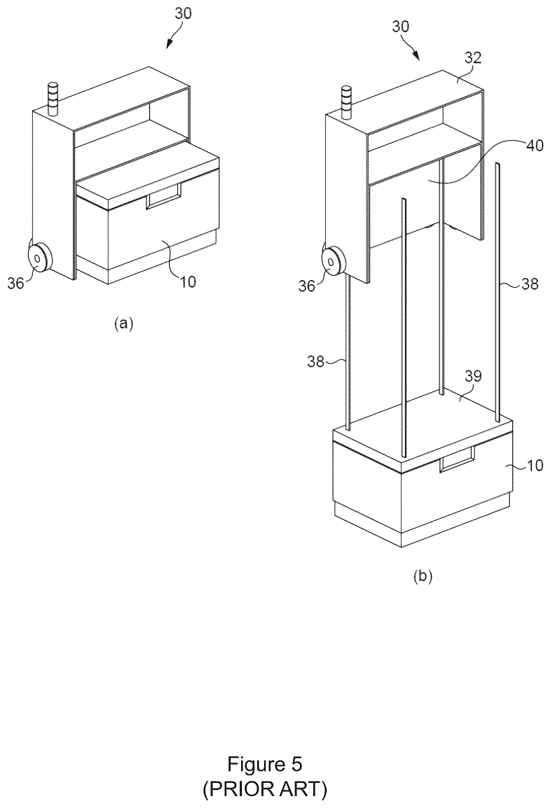

To ensure that the grabber device remains horizontal, is it is important that the length of all of the lifting tethers paid out from the first and second sets of spools is kept the same at all times during operation of the grabber device. To ensure that the length of all of the lifting tethers anchored to the grabber device are equal such that the grabber device is kept horizontal during operation, the length of each of the lifting tethers is preferably adjusted, both initially and at various service intervals, since the lifting tethers tend to elongate or stretch over time. The necessity for periodic adjustment can be attributed to numerous factors such as environmental, motor wear, stretching of the tape and so on. In an extreme case where the length of any one of the lifting tether is not equal, the grabber device may fail to engage with the container either because its descent falls too short or over shoots the container. The lifting tethers are shown in FIGS. 5 and 7 connected and spooled onto separate spools arranged within an upper level of the housing or body of the load handling device. The travel length of a lifting band per rotation of the spool onto which the lifting band is reeled is dependent on the number of layers of the lifting band wound onto the spool.

To adjust a lifting tether and to remove any slack in the spool, the corresponding spool or reel may be disconnected from its lifting shaft and the tape adjusted by free rotation of the reel or spool relative the rotational shaft. The reel or spool is subsequently mounted to the lifting shaft when the band has the desired length. A variant to this method is to provide adjustable lifting band connectors fixed to the container gripping assembly as taught in the above-noted WO 2019/206438 (Autostore Technology). Each adjustable lifting connector comprises a bracket and a band connector hub. The bracket is connected to the container gripping assembly and the band connector hub is connected to the bracket and one of the lifting bands, such that movement of the band connector hub relative to the bracket will adjust the vertical distance between a respective corner section of the container gripping assembly and the lifting band drive assembly.

Even if the length of the lifting tethers on any one of the spools can be adjusted, there is still the possibility that the length of any one of the lifting tethers can vary in comparison to the rest of the lifting tethers on their respective spools with the consequential effect of affecting the orientation of the grabber device. The further the grabber device moves away from its horizontal orientation, the greater the risk that the grabber device will foul one or more of the vertical uprights of the grid framework structure. In a worst-case scenario, the grabber device may get stuck down a storage column removing the ability of the container lifting assembly of the robotic load handling device to retrieve the grabber device and any storage container attached to the grabber device.

Other factors besides the orientation of the grabber device can affect the grabber device getting stuck down a storage column. These include but are not limited to the malfunction of any of the components of the container lifting assembly described above. For example, a malfunction of the lifting drive mechanism such as the loss of power to the lifting drive mechanism can prevent the container lifting mechanism or container lifting assembly from winching the grabber device. As the grabber device is still attached to the robotic load handling device by the lifting tethers, the prevention of the container lifting assembly from raising the grabber device above the tracks will prevent the robotic load handling device from being moved on the tracks resulting in the robotic load handling device being stranded on the tracks.

For the purpose of the present invention, to enable the robotic load handling device to move on the tracks, the grabber device and any storage container attached to the grabber device are preferably raised above the tracks. Typically, the grabber device and any storage container attached to the grabber device is raised into the container receiving space within the body of the robotic load handling device. For example, the container receiving space may comprise a cavity or recess arranged within the vehicle body, e.g., as described in the above-noted WO 2015/019055 (Ocado Innovation Limited). Alternatively, the vehicle body of the load handling device may comprise a cantilever as taught in the above-noted WO2019/238702 (Autostore Technology AS) in which case the container receiving space is located below a cantilever of the load handing device. In this case, the grabber device is hoisted by a cantilever such that the grabber device is able to engage and lift a container from a stack into a container receiving space below the cantilever. In all cases, the grabber device and any storage container attached to the grabber device is lifted above the tracks for the robotic load handling device to move on the tracks.

In an event that the grabber device and/or storage container attached to the grabber device is stuck or stranded down a storage column preventing the robotic load handling device being moved on the tracks, typically an operator would have to cut the lifting tethers to free up the grabber device from the body of the robotic load handling device. This could result in the grabber device and any storage container attached to the grabber device falling down a storage column. For a twenty-one-container-high grid framework structure, this could represent a huge drop down a storage column and substantial damage to the structure of the grabber device and/or the storage container attached to the grabber device.

Examples and embodiments of the present invention have mitigated this problem by providing an adaptor or an attachment or a tool 74 that can be retrofitted onto the body of the robotic load handling device so as to allow a separate rotational drive mechanism 76 to override the lifting drive mechanism 48 of the container lifting assembly 42. In the particular example of the present invention, the rotational drive mechanism can be a handheld drill 76. However, the rotational drive mechanism is not limited to a handheld drill within the scope of the present disclosure; embodiments and examples can utilize or include any rotational drive mechanism that is able to override the lifting drive mechanism of the container lifting assembly to winch the grabber device above the tracks, i.e., drive the first and second sets of spools.

To winch the grabber device 39 above the tracks, the rotational drive mechanism 76 should be able to connect to anyone of the components of the container lifting assembly so as to drive rotation of the first and second sets of spools 58, 60. These include but are not limited to any one of the plurality of pulleys, spools, lifting shafts and even the lifting drive mechanism itself. In all cases, the rotational drive mechanism 76 is configured to override the lifting drive mechanism of the container lifting assembly.

In the particular example of the present invention shown in FIG. 7, views (a) and (b), a rotational torque is applied to the drive pulley 66 mounted on the lifting drive shaft 68. As the first and second sets of spools 58, 60 are connected to the drive pulley 66 via their respective pulleys and drive belts, applying a rotational torque to the drive pulley 66 will drive rotation of the first and second sets of spools 58, 60, which in turn will raise the grabber device 39.

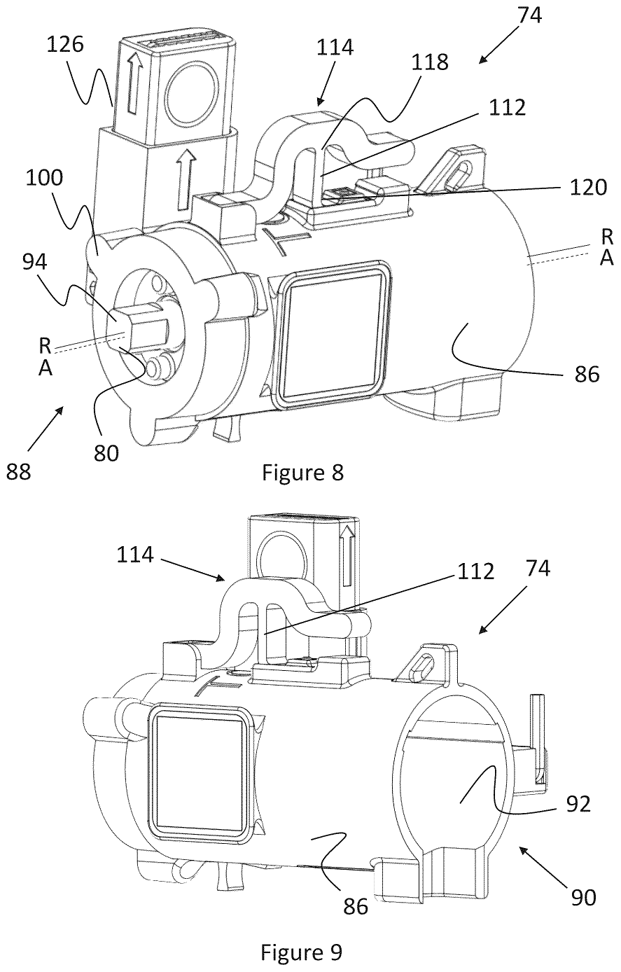

An example of the adaptor 74 that can be retrofitted onto the body of the robotic load handling device so as to allow an external rotational drive mechanism 76 to override the lifting drive mechanism 48 of the container lifting assembly is shown in FIG. 7, views (a) and (b), and FIG. 8.

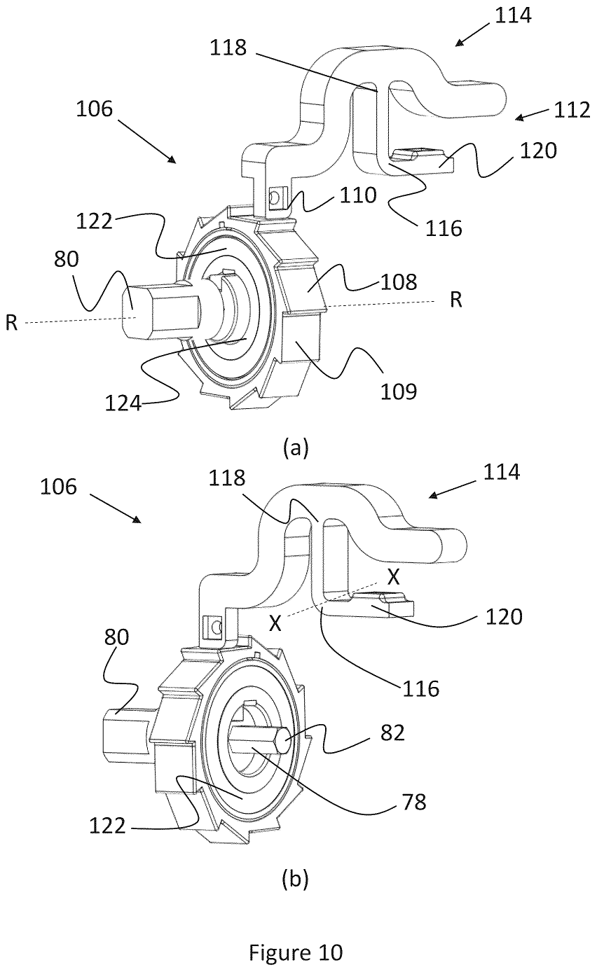

The adaptor 74 comprises a shaft 78 rotatable about a rotational axis, R (see FIG. 10). The container lifting assembly can be configured such that rotation of the drive pulley 66 in a first rotational direction raises the grabber device 39 and rotation of the drive pulley 66 in the second rotational direction lowers the grabber device 39. The first rotational direction can be either in the clockwise direction or the anti-clockwise direction. Likewise, the second rotational direction can be either in the anti-clockwise direction or the clockwise direction. The rotational direction of the drive pulley to raise or lower the grabber device largely depends on the arrangement of the first and second sets of spools on their respective first and second lifting shafts. The rotational direction of the lifting drive mechanism 48 can correspond to the rotational direction of the drive pulley 66 or can be different to the rotational direction of the drive pulley 66 to raise and lower the grabber device and largely depends on the connection between the lifting drive mechanism 48 and the drive pulley 66. In the particular embodiment of the present invention shown in FIG. 7, views (a) and (b), the lifting drive mechanism 48 drives the drive pulley 66 via a single drive belt and therefore, rotates in the same direction.

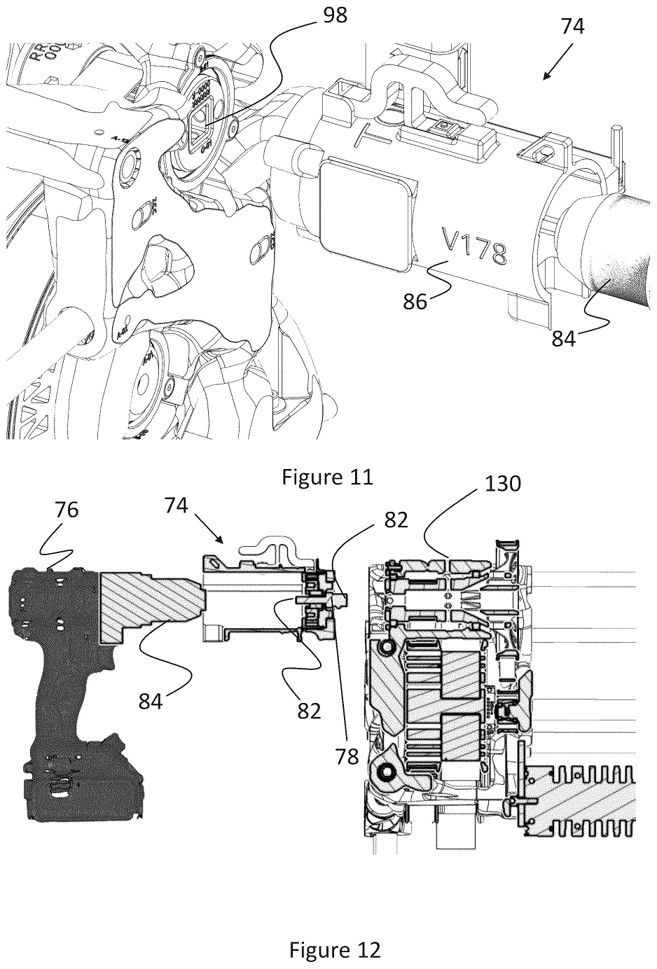

The shaft 78 comprises a first end 80 configured to engage with the drive pulley 66 and a second end 82 configured to engage with the rotational drive mechanism 76. Thus, rotation of the rotational drive mechanism drives rotation of the drive pulley 66 via the shaft 78. Since the grabber device is raised by rotating the drive pulley 66 in the first rotation direction and is lowered by rotating the drive pulley 66 in the second rotational direction, rotation of the rotational drive mechanism in the first rotational direction raises the grabber device and rotation of the rotational drive mechanism in the second rotational direction lowers the grabber device. In the case where the rotational drive mechanism is a handheld drill 76, the second end 82 of the shaft is configured to be received within a chuck 84 of the handheld drill 76 (see FIGS. 11 and 12). To support the rotational drive mechanism 76 when offered up to the drive pulley 66 of the container lifting assembly, the adaptor 74 comprises a body 86 having a first portion 88 for engaging or interfacing with the body of the robotic load handling device and a second portion 90 for coupling with the rotational drive mechanism 76.

Further detail of engagement of the first portion of the body of the adaptor with the robotic load handling device will be discussed below. The second portion 90 of the body 86 of the adaptor comprises an opening 92 for receiving the rotational drive mechanism, more specifically, the chuck 84 of the handheld drill, so as to connect to the second end 82 of the shaft (see FIGS. 7, 9 and 11). In the particular embodiment of the present invention, the body 86 of the adaptor is formed as an elongated body having a longitudinal axis, A, that is parallel to the rotational axis R-R of the shaft 78. In the particular example of the present invention shown in FIGS. 8 and 10 view (a), the longitudinal axis A-A of the body 86 of the adaptor is coaxial to the rotational axis R-R of the shaft for engaging with the drive pulley 66 and the rotational drive mechanism 76. As the front end of the elongated body is configured to interface with the drive pulley and the second end of the elongated boy is configured to receive the rotational drive mechanism, the first portion 88 of the body of the adaptor can be defined as a front-end portion and the second portion 90 of the body of the adaptor can be defined as a rear end portion.

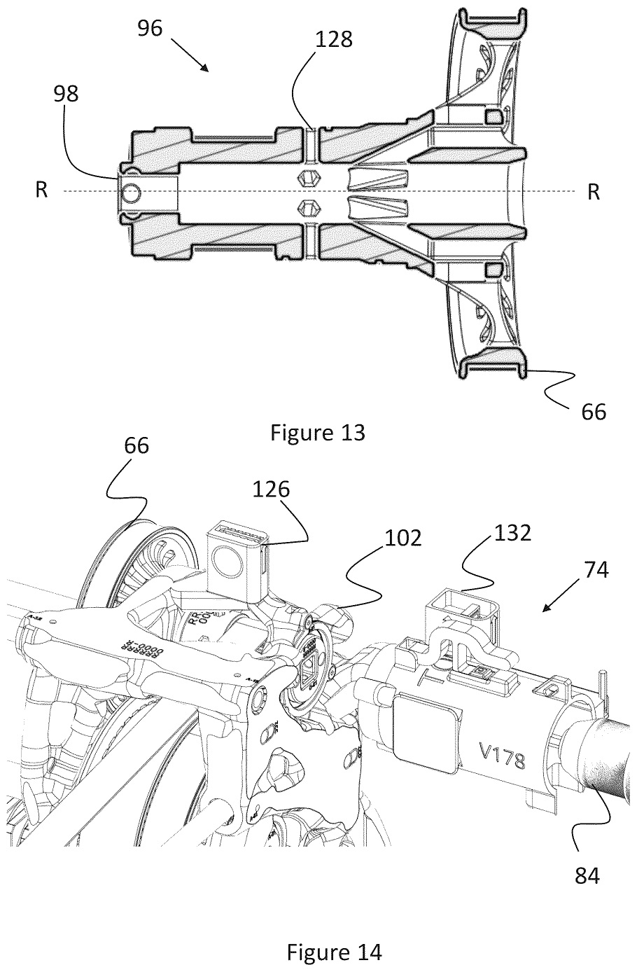

The first end 80 of the shaft 78 extends through the body 86 of the adaptor to define a drive bit or key 94 that is configured to engage with the drive pulley 66. To enable the drive bit 94 of the shaft 78 to engage with the drive pulley 66, the drive pulley is adapted with an extension 96 in the form of a connector having an opening 98 to receive the drive bit 94 (see FIGS. 13 and 14). The shape of the opening 98 corresponds to the shape of the drive bit 94 such that rotation of the drive bit 94 is transmitted to the drive pulley 66 about the rotational axis R-R. As the drive pulley 66 is connected to the first and second set of timing pulleys 70, 72 by respective timing belts/gears, rotation of the drive bit 94 is transmitted to the first and second set of timings pulleys 70, 72 via the drive pulley, which in turn rotates the first and second sets of spools 58, 60 to raise the grabber device.

In the particular example of the present invention shown in FIGS. 8 and 10 view (a), the drive bit 94 has a substantially square cross-sectional shape that is received in a correspondingly square shaped opening 98 in the connector 96 of the drive pulley 66 (see FIG. 14). The connector 96 and the drive pulley 66 can be formed as separate parts that are attached together, e.g., the use of fasteners or adhesive, or formed as a single, integral part, e.g., 3D printed or injection molded part.

To engage the first portion of the body 88 of the adaptor to the body of the robotic handling device, the first portion of the body 88 of the adaptor comprises one or more engagement features 100 that are configured to engage with correspondingly shaped engagement features 102 in the body of the robotic load handling device. In the particular example of the present invention shown in FIG. 8, the first portion of the body 88 of the adaptor comprises one or more nodules or lobes 100 that are shaped to be received in one or more correspondingly shaped depressions 102 in the body of the robotic load handling device (see FIG. 14). The one or more nodules 100 function to lock the body of the adaptor to the body of the robotic load handling device and prevent the body of the adaptor from rotating when the shaft 78 is driven by the rotational drive mechanism 76. When the first portion of the body 88 of the adaptor is locked against the body of the robotic load handling device, the rotational drive mechanism drives rotation of the shaft 78 relative to the body of the adaptor, which in turn drives rotation of the drive pulley. Without locking the body of the adaptor against the body of the robotic load handling device, the torque of the rotational drive mechanism is transmitted to the operator's hand holding the rotational drive mechanism. Considering that a storage container can weigh as much as 35 kg, the torque necessary to raise the grabber device can impart undue stress on the operator's hand holding the rotational drive mechanism. By locking the body of the adaptor against the body of the robotic load handling device, the reaction forces generated from the torque of the rotational drive mechanism is transmitted to the body of the load handling device, i.e. the body of the adaptor is anchored to the body of the robotic load handling device to absorb the reaction forces. In the particular example of the present invention, the first portion of the body 88 of the adaptor engages with the body of the robotic load handling device by engaging with a mount or connecting block 104 supporting the drive pulley as shown in FIG. 7, views (a) and (b).

To override the lifting drive mechanism, it is sometimes necessary to disconnect the lifting drive mechanism 48 from the drive pulley 66. This may involve decoupling the drive belt (not shown) connecting the lifting drive mechanism, e.g. motor, from the drive pulley. Decoupling the drive pulley from the lifting drive mechanism may involve cutting the drive belt connecting the lifting drive mechanism. As a result of this disconnection, the drive pulley and the first and second sets of pulleys coupled to the drive pulley would freely rotate as there is no resistance to prevent the drive pulley freely rotating. A problem will arise when the rotational drive mechanism overrides the lift drive mechanism and winches the grabber device and any storage container attached to the grabber device above a stack of storage container. Without any resistance applied to the drive pulley, there is the risk that the drive pulley 66 will freely rotate if the torque from the rotational drive mechanism is removed from the drive pulley. As the first and second sets of spools are coupled to the drive pulley via the first and second sets of pulleys, this will result in the grabber device and any storage container attached to the grabber device to fall down a storage column.

To lock the shaft 78 and thereby prevent the lifting tethers from unwinding on the first and second sets of spools 58, 60, particularly when the rotational drive mechanism is disconnected from the drive pulley, the adaptor 74 further comprises a releasable braking mechanism 106, see FIG. 10, views (a) and (b). The braking mechanism 106 is coupled to the shaft and enables braking of the rotation of the shaft 78, and thereby the drive pulley 66, in the second rotational direction. The second rotational direction is the rotational direction of the drive pulley to lower the grabber device. In the particular example of the present invention shown in FIG. 10, views (a) and (b), the releasable brake mechanism is a releasable one-way brake mechanism comprising a ratchet wheel 108 comprising a plurality of teeth 109 radially extending therefrom. The ratchet wheel 108 is arranged in rotation with the shaft 78 of the adaptor and relative to a pawl 110 pivotally mounted to the body of the adaptor 86. The pawl 110 is engageable with at least one of the plurality of teeth 109 of the ratchet wheel 108 to brake rotation of the shaft 78 and hence, rotation of the drive pulley 66. The ratchet wheel 108 is shown in the illustrated embodiment in FIG. 10, views (a) and (b) mounted to the shaft 78 such that rotation of the shaft 78 drives rotation of the ratchet wheel 108. The plurality of teeth 109 are arranged on the ratchet wheel 108 such that the shaft 78 is prevented from rotating in the second rotational direction when the pawl 110 is engaged with the teeth 109 to a ratchet engaged position. To release the one-way brake mechanism 106 and permit the ratchet wheel 108 and thus, the shaft mounted thereon to rotate, the pawl 110 is disengaged from the teeth 109 of the ratchet wheel 108. The position of the pawl 110 when the pawl is disengaged from the teeth 109 of the ratchet wheel 108 is herein defined as a ratchet released position.

The pawl 110 is shown in FIG. 10, views (a) and (b), as being pivotally mounted or connected to the body of the adaptor by a hinge such that the pawl is moveable from the ratchet engaged position and the ratchet released position. The pawl 110 is biased by a resilient member 112 in the ratchet engaged position such that the pawl 110 is moved to the ratchet released position by overcoming the bias of the resilient member 112. In the illustrated embodiment shown in FIGS. 8 to 10, the one-way braking mechanism comprises a locking lever 114 connected to the pawl 110 to move the pawl to the ratchet released position. The locking lever 114 is rotates about a hinge axis X-X defined by the hinge—see FIG. 10, view (b)—to move the pawl between the ratchet engaged position and the ratchet engaged position. In the particular example shown in FIGS. 8 and 9, the locking lever 114 rotates about the hinge defined by the resilient member 112. The resilient member 112 comprises a deformable member 116 having a first end 118 connected to the locking lever 114 and a second end 120 arranged to abut against the body of the adaptor 86. The deformable member is such that in its original position, the pawl 110 is biased against at least one of the plurality of teeth. To release the pawl from the plurality of teeth, a downward force is applied to the locking lever 114 causing the resilient member 112 to deform and the locking lever 114 to rotate about the hinge axis X-X. The deformation of the resilient member provides the biasing force to return the pawl to the ratchet engaged position. The advantage of forming the resilient member as a deformable member is that the pawl, the locking lever and the biasing member can be formed as a single, integral body, e.g. 3D printed or moulded.

The resilient member to bias the pawl in the ratchet engaged position is not limited to the deformable member discussed above and can by any biasing means to bias the pawl in the ratchet engaged position. For example, the resilient member can be a spring connected to the locking lever to bias the pawl in the ratchet engaged position. Equally, the pawl can be biased in the ratchet released position and to brake rotation of the shaft requires overcoming the resilient member. Equally applicable in the present invention is that the one-way braking mechanism is not limited to the ratchet wheel discussed above and can be any type of indexing means that engages with a pawl to brake rotation of the shaft.

In the case where the rotational drive mechanism has two rotational settings in a clockwise and anti-clockwise direction, e.g. as found in a typical handheld drill, there is the risk that the rotational drive mechanism can be set to drive the drive pulley in the wrong rotational direction, i.e. the second rotational direction, resulting in the lifting tethers being excessively paid out from their respective spools. If the grabber device is stuck against the vertical uprights in a storage column, excessively spooling out the lifting tethers from their respective spools can result in entanglement of the lifting tethers. To prevent the rotational drive mechanism from inadvertently driving the drive pulley in the second rotational direction, the ratchet wheel 108 is mounted to the shaft 78 of the adaptor via a one-way clutch or sprag clutch 122. Mounting the ratchet wheel 108 to the one-way clutch 122 can be via a spline and groove assembly. See FIG. 10, views (a) and (b). The one-way clutch 122 is arranged so that the shaft 78 transmits a rotational torque to the one-way brake mechanism in the first rotational direction to raise the grabber device but free-wheels in the second rotational direction, thereby preventing the shaft from driving rotation of the drive pulley in the second rotational direction. As a result, the one-way clutch 122 provides an additional safety feature to prevent the rotational drive mechanism from inadvertently driving rotation of the drive pulley in the second rotational direction. The one-way clutch 122 can optionally be mounted to the shaft 78 by a bush (a.k.a., bushing) 124 as illustrated in the embodiment shown in FIG. 10, views (a) and (b).

In use, when winching a grabber device above the tracks, the adaptor 74 of the present invention is offered up to the drive pulley 66 such that the first portion of the body 88 of the adaptor interfaces with the body of the robotic load handling device and the drive bit 94 is received in the connector 96 of the drive pulley 66 as illustrated in FIGS. 7, 11 and 12. In some cases, the drive belt connecting the lifting drive mechanism, e.g. motor, to the drive pulley would need to be disengaged or cut to free up the drive pulley 66 from the lifting drive mechanism 48.

The adaptor 74 allows a handheld drill 76 to be coupled to the drive pulley 66 and override the lifting drive mechanism 48. The handheld drill 76 is offered up to the adaptor 74 such that the chuck 84 of the handheld drill is received within the opening 92 in the second portion of the body 90 of the adaptor and engage with the second end of the shaft 82 as shown in FIGS. 11 and 12. The one-way brake mechanism 106 prevents the drive pulley 66 from rotating when the lifting drive mechanism 48 is decoupled from the drive pulley 66. Releasing the one-way brake mechanism allows the handheld drill to drive rotation of the shaft 78 which in turn drives rotation of the first and second sets of spools 58 60 to raise the grabber device.

Once the grabber device is raised above the tracks, the one-way brake mechanism 106 can be re-applied to prevent the drive pulley from rotating and the raised grabber device falling back down the storage column. Once, the grabber device and any storage container attached to the grabber device is raised above the tracks, the robotic load handling device is allowed to be moved on the tracks.

In some scenarios, a simple agitation of the grabber device can loosen the grabber device and free it up from its storage column. Agitating the grabber device can simply involve repeatedly applying a tension to the lifting tethers by pulling on the lifting tethers and releasing the tension causing the grabber device to be lifted and lowered repeatedly until the grabber device is free. The adaptor of the present invention can also be used to free up a grabber device stuck in a storage column.

The adaptor 74 of the present invention can function as a tool that be can be disconnected from the robotic load handling device for use elsewhere on another robotic load handling device. To enable the adaptor to be disconnected from the robotic load handling device when the grabber device has been winched above the tracks, optionally, the adaptor 74 further comprises a removable locking member 126 for engaging with the drive pulley.

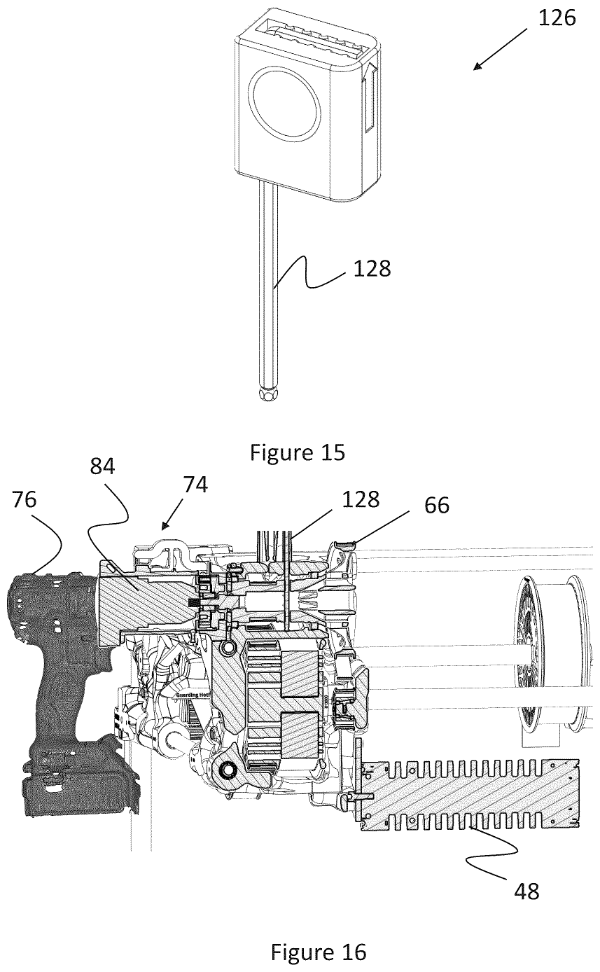

In the illustrated embodiment shown in FIG. 15, the removable locking member 126 is in form of a locking pin 128 that can be inserted into an opening or slot 130 in the connector 96 of the drive pulley as shown in FIGS. 13 and 16. The locking pin 128 locks the connector 96 against the body of the robotic load handling device and prevents the drive pulley from rotating as shown in the cross-section of the adaptor 74 engaged with the body of the robotic load handling device in FIG. 16. To make the locking pin 128 available once the grabber device has been raised and for safe keeping of the locking pin, the body of the adaptor 86 is adapted with a seat 132 to accommodate the locking pin 128 (see FIG. 14).

In use, once the grabber device is raised above the tracks, the locking pin 128 is removed from its seat and inserted into the connector of the drive pulley to lock the drive pulley in its current position as demonstrated in FIG. 16. Once the drive pulley is locked, the adaptor and the rotational drive mechanism can be safely decoupled from the drive pulley. More than one locking pin can be used to lock rotation of the drive pulley. For example, the locking pin can comprise first and second locking pins (not shown) that are configured to be inserted into respective first and second openings in the connector. The second locking pin provides some level of redundancy to the locking of the drive pulley should the first locking pin is prevented from being inserted into the first opening. To ensure that the second locking pin is inserted in the connector, the second opening is larger than the first opening. Should the first locking pin be prevented from being inserted into the first opening, the diameter of the second locking pin in comparison to the larger opening of the second opening allows the second locking pin to be inserted into the second opening.

Typically, the lifting drive mechanism of the container lifting assembly can have a built-in clutch or brake (not shown) that can be released by an actuator (not shown). In the case where the lifting drive mechanism is a motor comprising a motor drive shaft, the clutch or brake prevents the motor drive shaft from rotating until the clutch or brake is released; the default position being that the brake or clutch is constantly applied to prevent the motor drive shaft from rotating. To release the brake or clutch and to free up the motor drive shaft, electrical power is supplied to the actuator by a control system internal of the robotic load handling device when the robotic load handling device is instructed to retrieve a storage container from a stack of storage containers. However, the power to actuate the clutch or brake of the lifting drive mechanism can be bypassed by an external power source. Typically, the power necessary to actuate the brake or clutch of the lifting drive mechanism is in the range 1.5v to 5v; other voltages may be used within the scope of the present disclosure.

Instead of the adaptor comprising the one-way brake mechanism to brake rotation of the drive pulley, the adaptor according to a second embodiment of the present invention can optionally make use of the brake or clutch of the lifting drive mechanism. All of the other features of the adaptor discussed above such as the shaft and the locking pin are present in the second embodiment of the adaptor.

In the second embodiment of the present invention, the adaptor can comprise a circuit comprising a power source and electrical contacts for supplying power to actuate the brake or clutch of the lifting drive mechanism and release the motor drive shaft. This removes the need to have a separate braking mechanism to release the motor drive shaft. The circuit can optionally comprise a switch for controlling the supply of power to actuate the brake or clutch of the lifting drive mechanism. As the drive pulley is coupled to the motor drive shaft by a drive belt, releasing the motor drive shaft to freely rotate removes the need to cut the drive belt to the drive pulley.

In use, when the adaptor of the present invention is offered up to interface with the drive pulley, an electrical contact is made with the lifting drive mechanism to supply power to actuate the brake or clutch and free up the drive pulley from the motor drive shaft. As a result, torque from the rotational drive mechanism coupled to the adaptor of the present invention can be transmitted to the drive pulley via the shaft, and since the first and second sets of spools are coupled to the drive pulley, the grabber device is raised. However, the adaptor according to the second embodiment of the present invention can additionally comprise the releasable one-way brake mechanism 106 discussed above with reference to FIG. 10, views (a) and (b), in addition to the brake of the lifting drive mechanism. The one-way brake mechanism 106 provides an additional safety feature to prevent the lifting tethers from inadvertently being paid out from the first and second sets of lifting spools.

As a further safety feature, most current handheld drills comprise a built-in brake or clutch mechanism to prevent the chuck from rotating in an opposite direction to the direction in which the drill has been originally set. When coupled to the adaptor of the present invention, the brake or clutch mechanism of the handheld drill can be used to prevent the shaft, and thus the drive pulley, from inadvertently rotating in the second rotational direction. However, in some cases, the brake or clutch mechanism of the handheld drill does not apply enough resistance to the drive pulley to prevent the grabber device and any storage container attached to the grabber device from falling down a storage column. This can be particularly the case when the storage container weighs in excess of 30 kg. The releasable one-way brake mechanism discussed above with reference to FIG. 10, views (a) and (b), provides additional reassurance to prevent the grabber device and any storage container attached to the grabber device from falling back down a storage column once winched above the tracks by the handheld drill.

The present invention has been described in an illustrative manner and many modifications of the present invention are possible in light of the above teachings without departing from the scope of the claims. For example, the present invention can rely on the braking mechanism in the rotational drive mechanism rather than having a separate braking mechanism to prevent rotation of the shaft. In this case, the present invention provides a kit of parts comprising an adaptor comprising a shaft having a first end configured to releasably couple with the container lifting assembly and a second end configured to releasably couple with a rotational drive mechanism such that, in use, the rotational drive mechanism overrides the lifting drive mechanism to raise the grabber device in the first rotational direction of the rotational dive mechanism; and a rotational drive mechanism coupled to the second end of the shaft, the rotational drive mechanism comprising a brake mechanism configured to brake rotation of the shaft in the second rotational direction. All other features of the adaptor such as the body this is configured to interface with at least one of the plurality of timing pulleys is still present in the adaptor but the adaptor relies on the braking mechanism of the rotational drive mechanism, e.g. handheld drill. All patents and patent applications noted herein are incorporated by reference herein in their respective entireties.

What is claimed is:

1. An adaptor for coupling a rotational drive mechanism to a container lifting assembly of a robotic load handling device, the container lifting assembly comprising (i) a grabber device configured to engage with a storage container; (ii) a plurality of timing pulleys and; (iii) a lifting drive mechanism comprising a drive shaft coupled to the plurality of timing pulleys for raising and lowering the grabber device, the adaptor comprising;—
(a) a body comprising a first portion configured to engage with the robotic load handling device and a second portion having an opening for receiving the rotational drive mechanism;
(b) a shaft having a first end extending through the body to define a drive bit, the drive bit being configured to releasably couple with the container lifting assembly and a second end configured to releasably couple with the rotational drive mechanism such that in use, when the drive bit is coupled to the container lifting assembly, the rotational drive mechanism overrides the lifting drive mechanism of the container lifting assembly to raise the grabber device in a first rotational direction of the rotational drive mechanism and lower the grabber device in a second rotational direction of the rotational drive mechanism; and
(c) a releasable brake mechanism coupled to the shaft and configured to brake rotation of the shaft in the second rotational direction.

2. The adaptor of claim 1, wherein the releasable brake mechanism is a releasable one-way brake mechanism comprising:
(i) a ratchet wheel comprising a plurality of teeth radially extending therefrom;
(ii) a pawl moveable between a ratchet engaged position, in which the pawl is engaged with at least one of the plurality of teeth to brake rotation of the ratchet wheel in the second rotational direction and a ratchet released position to permit rotation of the ratchet wheel.

3. The adaptor of claim 2, further comprising a locking lever coupled to the pawl to move the pawl between the ratchet engaged position and the ratchet released position.

4. The adaptor of claim 2, wherein the pawl is biased in the ratchet engaged position.

5. The adaptor of claim 2, wherein the shaft is coupled to the brake mechanism by a one-way or sprag clutch for transferring rotation of the shaft to the brake mechanism in the first rotational direction.

6. The adaptor of claim 5, wherein the ratchet wheel is mounted to the one-way clutch.

7. The adaptor of claim 6, wherein with the one-way clutch is mounted to the shaft by a bushing.

8. An adaptor for coupling a rotational drive mechanism to a container lifting assembly of a robotic load handling device, the container lifting assembly comprising (i) a grabber device configured to engage with a storage container and; (ii) a lifting drive mechanism comprising a lifting drive shaft coupled to a plurality of timing pulleys for raising and lowering the grabber device, (iii) a brake mechanism configured to prevent rotation of the lifting drive mechanism, (iv) an actuator to release the brake mechanism, the adaptor comprising;—
(a) an electrical circuit comprising a power source and electrical contacts for supplying power to actuator to release of the brake mechanism and permit rotation of the motor drive shaft; and
(b) a shaft having a first end configured to releasably couple with the container lifting assembly and a second end configured to releasably couple with a rotational drive mechanism such that, in use, when the actuator is actuated, the rotational drive mechanism overrides the lifting drive mechanism to raise the grabber device in a first rotational direction of the rotational dive mechanism.

9. The adaptor of claim 8, wherein the rotational drive mechanism is a handheld device.

10. The adaptor of claim 9, wherein the handheld device comprises a handheld drill.

11. The adaptor of claim 8, further comprising a removable locking member for engaging with the at one of the plurality of pulleys to prevent rotation of the at least one of the plurality of pulleys.

12. The adaptor of claim 8, wherein the first portion of the body comprises one or more engagement features configured to engage with the robotic load handling device such that the shaft rotates the drive bit relative to the body when the body is engaged with the robotic load handling device.

13. A kit of parts comprising:
(A) an adaptor for coupling a rotational drive mechanism to a container lifting assembly of a robotic load handling device, the adaptor comprising, the adaptor comprising;—
(a) an electrical circuit comprising a power source and electrical contacts for supplying power to actuator to release of the brake mechanism and permit rotation of the motor drive shaft; and
(b) a shaft having a first end configured to releasably couple with the container lifting assembly and a second end configured to releasably couple with a rotational drive mechanism such that, in use, when the actuator is actuated, the rotational drive mechanism overrides the lifting drive mechanism to raise the grabber device in a first rotational direction of the rotational dive mechanism; and
(B) a rotational drive mechanism releasably coupled to the second end of the shaft.

14. A robotic load handling device for lifting and moving one or more containers stackable in a storage and retrieval system, the storage and retrieval system comprising a grid framework structure comprising a plurality of tracks arranged in a grid pattern for guiding the movement of the load handling device on the grid structure, the load handling device comprising:
(a) a container lifting assembly comprising:—
(i) a grabber device configured to releasably grip a storage container,
(ii) a plurality of spools, each spool of the plurality of spools carrying a lifting tether having a first end anchored to the grabber device and a second end anchored to the spool,
(iii) a lifting drive mechanism; and
(iv) a plurality of timing pulleys to transfer rotation of the lifting drive mechanism to the plurality of spools to raise and lower the grabber device;
(b) a wheel assembly comprising a first set of wheels for engaging with a first set of grid members to guide movement of the load handling device in a first direction and a second set of wheels for engaging with a second set of grid members to guide the movement of the load handling device in a second direction, wherein the second direction is transverse to the first direction; and
c) a wheel positioning mechanism configured for selectively lowering or raising the first set of wheels or the second set of wheels into engagement or disengagement with the first set of grid members or the second set of grid members;
wherein at least one of the plurality of timing pulleys of the container lifting assembly is configured to interface with an adaptor configured for coupling a rotational drive mechanism to the container lifting assembly.

15. The robotic load handling device of claim 14, wherein the at least one of the timing pulleys comprises a drive pulley.

16. The robotic load handling device of claim 15, wherein the drive pulley comprises a connector for coupling with the first end of the shaft.

17. The robotic load handling device of claim 14, wherein the plurality of spools comprises a first set of spools and a second set of spools, the first set of spools being mounted on a first lifting shaft and the second set of spools being mounted on a second lifting shaft, the first lifting shaft being connected to the drive pulley and the second lifting shaft being connected to the first lifting shaft such that rotation of the drive pulley by the lifting drive mechanism drives rotation of the first and second sets of spools.

18. The robotic load handling device of claim 17, wherein the plurality of timing pulleys comprises a first timing pulley and a second timing pulley, the first timing pulley being mounted on the first lifting shaft and the second timing pulley being mounted on the second lifting shaft, the first lifting shaft is connected to the drive pulley via the first timing pulley and the second lifting shaft is connected to the first lifting shaft via the second timing pulley.
